(19) United States
(12) Patent Application Publication
(10) Pub. No.: US 2023/0231211 A1
(43) Pub. Date: Jul. 20, 2023

(54) Hybrid Battery Cartridge

(71) Applicant: IdeaPond LLC, Carlsbad, CA (US)

(72) Inventor: Dennis K. Bertken, Carlsbad, CA (US)

(73) Assignee: IdeaPond LLC, Carlsbad, CA (US)

(21) Appl. No.: 18/154,932

(22) Filed: Jan. 16, 2023

Related U.S. Application Data
(60) Provisional application No. 63/378,238, filed on Oct. 4, 2022.
(60) Provisional application No. 63/266,797, filed on Jan. 14, 2022.

(51) Int. Cl. H01M 10/48; H01M 16/00; H01M 6/50; F21L 4/08; F21V 23/02; H02J 7/00; H02J 7/34

(52) U.S. Cl. CPC H01M 10/482; H01M 10/488; H01M 16/00; H01M 6/505; F21L 4/08; F21V 23/023; H02J 7/0063; H02J 7/0048; H02J 7/005; H02J 7/0013; H02J 7/34; H02J 2207/30

(57) ABSTRACT

Systems, apparatus, and methods for managing power in a hybrid battery cartridge. The hybrid battery cartridge may output single-use battery power, rechargeable battery power, or both. Thus, a single battery cartridge may store multiple types of batteries and allow the batteries to be used separately or concurrently. In one example usage, the battery cartridge may be inserted into other devices to provide power. Additionally, the intelligent hybrid battery cartridge may be used as a stand-alone charger to charge other devices. The intelligent hybrid battery cartridge is designed to allow for retrofitting into existing single-use battery powered devices such as flashlights and lanterns to make them hybrid power enabled. The hybrid battery cartridge may select a power source based the type of load and/or on a reserve power threshold.

### PRIORITY

This application claims the benefit of priority to U.S. Patent Application No. 63/266,797 entitled “Hybrid Battery Cartridge” filed Jan. 14, 2022 and U.S. Patent Application No. 63/378,238 entitled “METHODS AND APPARATUS FOR DYNAMIC BATTERY MANAGEMENT” filed Oct. 4, 2022, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of battery cartridges or racks. More particularly, the present disclosure relates to a battery cartridge that enables hybrid operation of single-use and rechargeable batteries.

### DESCRIPTION OF RELATED TECHNOLOGY

Batteries provide a source of electric power for powering electrical devices. Most batteries include one or more electrochemical cells. When a battery is supplying electric power, its positive terminal is the cathode and its negative terminal is the anode. The negative terminal is the source of electrons that will flow through an external electric circuit to the positive terminal. When a battery is connected to an external electric load, a redox reaction converts high-energy reactants to lower-energy products, and the free-energy difference is delivered to the external circuit as electrical energy.

Single-use (also known as “disposable”, “primary”, and/or “dry” cell) batteries are used once and discarded because the electrode materials are irreversibly changed during discharge; one common example is the alkaline battery used for a multitude of portable electronic devices. A “dry” cell uses a paste electrolyte, with only enough moisture to allow current to flow. Unlike a wet cell, a dry cell can operate in any orientation without spilling, as it contains no free liquid, making it suitable for portable equipment. Other battery chemistries that may be found in single-use batteries include zinc-carbon cells, lithium cells, mercury cells, and silver-oxide cells.

Rechargeable (also known as “secondary” cell) batteries may be recharged and discharged multiple times. To recharge the cell, an electric current is applied to the cell to restore the original composition of the electrodes. Rechargeable batteries include lithium-ion batteries used for portable electronics such as laptops and mobile phones, and lead-acid batteries used in vehicles. Other battery chemistries that may be found in rechargeable batteries include nickel-cadmium cells and nickel-metal hydride cells.

Batteries come in many shapes and sizes; miniature cells may be used to power hearing aids and wristwatches-at the other extreme, huge battery banks the size of rooms may provide standby or emergency power for telephone exchanges and computer data centers. Flashlights and handheld devices often use “cylindrical cells”; cylindrical cells may be either single-use or rechargeable. Historically, cylindrical cells were commonly referred to by a generalized size nomenclature “AA”, “AAA”, “C”, “D”, etc. More recently rechargeable battery manufacturers have adopted more physical form factor nomenclatures (e.g., 18650 refers to a lithium-ion battery of 18 mm×65 mm; 14000 refers to a lithium-ion battery of 14 mm×50 mm, etc.). Cylindrical cells may be used “loose” or in battery cartridges/racks.

### BRIEF DESCRIPTION OF THE DRAWINGS

FIG. 1 is a graph illustrating exemplary discharge curves for single-use and rechargeable batteries.

FIG. 2 illustrates an exemplary flashlight device that can accept a battery cartridge.

FIG. 3 illustrates voltage measurements for a Pulse Width Modulated (PWM) Light Emitting Diode (LED), useful to illustrate battery capacity measurements under dynamic loading conditions.

FIG. 4 illustrates six faces of an exemplary hybrid battery cartridge, useful to teach aspects of the present disclosure.

FIG. 5 illustrates an exploded view of an exemplary hybrid battery cartridge, useful to teach aspects of the present disclosure.

FIG. 6 is a circuit diagram illustrating exemplary circuits on one or more printed circuit boards (PCBs) of a hybrid battery cartridge, useful to teach aspects of the present disclosure.

FIG. 7 is a logical block diagram of one exemplary hybrid battery cartridge useful to illustrate various aspects of the present disclosure.

FIG. 8 is a graphical representation of two perspective views of the physical form factor corresponding to the hybrid battery cartridge of FIG. 7.

FIG. 9 is a logical flow diagram illustrating an example method according to the present disclosure.

FIG. 10 is a logical flow diagram of a method for determining a battery usage configuration based on the operating mode, in accordance with various aspects of the present disclosure.

### DETAILED DESCRIPTION

In the following detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

### Single-use and Rechargeable Batteries

Battery powered products today provide the singular option of single-use battery power or rechargeable battery power. This “either or” scenario dramatically limits the ability to use the battery power products in many cases. Compared to rechargeable batteries, single-use batteries store charge longer in extreme temperatures and when not in use. The “self-discharge rate” is the rate at which the stored charge in a battery is reduced due to internal chemical reactions of the battery. Certain types of alkaline batteries, for example, have a shelf life of ten years. Single-use batteries are therefore well suited for emergency-use applications.

Single-use batteries must be replaced after use/complete discharge; thus, a cost comparison of single-use batteries and their rechargeable counterparts should consider replacement cost and access to recharging power. Many high-power output products today consume single-use batteries in just a few hours, and performance is frequently inferior to rechargeable batteries at low battery life. Replacement costs can quickly eclipse the low per unit cost of single-use batteries. Further, rechargeable batteries, while having a larger up-front cost than single-use batteries, can be recharged with relatively inexpensive power from, e.g., an outlet. As a result, rechargeable batteries allow for more cost-effective use over their lifetime. Unfortunately, rechargeable batteries require access to external power DC power to recharge the batteries. If the power is unavailable due to, e.g., a blackout or a person is away from the DC power source, then they can find themselves without the ability to power their devices.

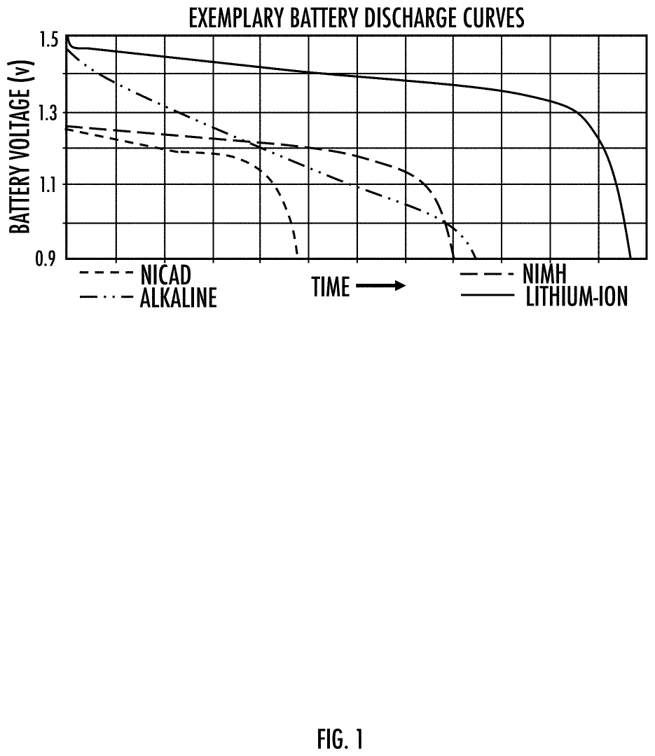

FIG. 1 is a graph illustrating exemplary discharge curves for single-use and rechargeable batteries. The graph illustrates the discharge curves (voltage) of four types of battery chemistries over time of use. Alkaline manganese dioxide (alkaline) batteries are single-use batteries. Nickel-cadmium (NiCAD) batteries, nickel-metal hydride (NiMH) batteries and lithium-ion batteries are rechargeable batteries. Even though all battery chemistries lose voltage over time, alkaline batteries (which are the most popular type of single-use battery) lose voltage at an almost constant rate over the span of discharge. Rechargeable battery chemistries lose voltage at a far slower rate, and drop-off before the battery is depleted. Notably, the differences in discharge rates means that single-use and rechargeable cells should not be directly electrically coupled together; doing so may cause the cells to load one another unevenly and/or may reduce output, damage the cells, and in extreme cases, cause rupture and cell leakage.

As a brief aside, the relatively constant rate of discharge for alkaline batteries simplifies battery life determination compared to other battery chemistries; the remaining alkaline battery life can be directly estimated based on the output voltage (when not under load). Unfortunately, the lack of a consistent voltage level also makes the use of alkaline batteries less effective in certain types of applications, e.g., for use in electronics. In contrast, rechargeable battery chemistries can provide a relatively more consistent voltage level but may require more complex battery life determination (e.g., based on draw, temperature, usage, etc.)

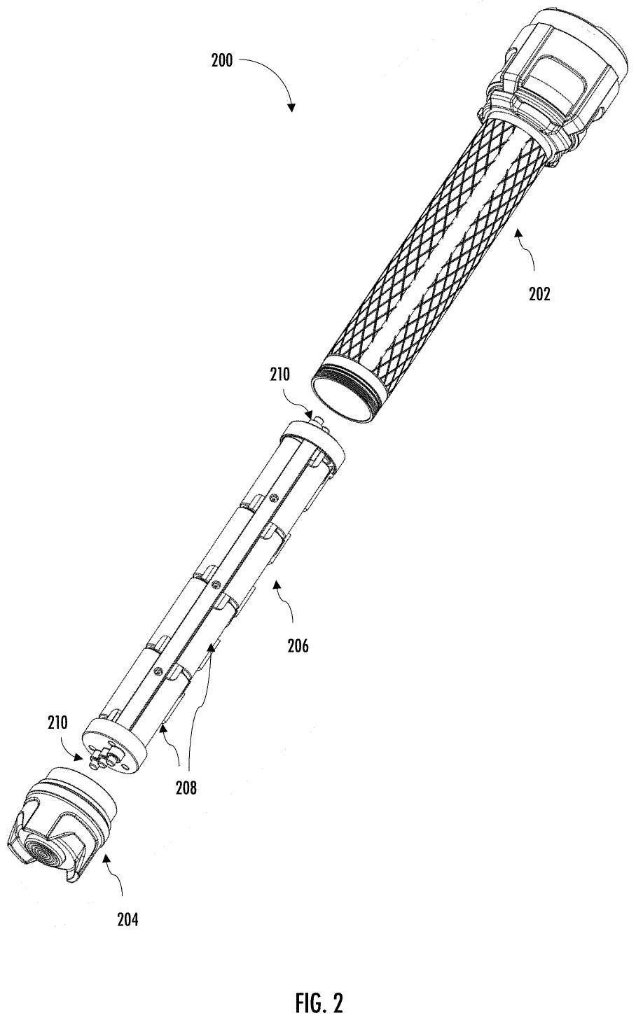

FIG. 2 illustrates an exemplary flashlight device 200 that can accept a battery cartridge 206. The flashlight device 200 has a main body 202 and a removable back cap 204. Once the removable back cap 204 is removed, a battery cartridge 206 with installed batteries 208 may be inserted into the main body 202 and the removable back cap 204 replaced. The electrical contacts 210 on the battery cartridge 206 electrically connect the battery cartridge 206 with contacts inside the flashlight device 200. In some examples, the battery cartridge 206 is completely encapsulated when installed in the device. In other examples, the battery cartridge 206 attaches to (and is not completely encapsulated by) the device.

Dual power devices are devices that are designed to accept either single-use or rechargeable cells, but not at the same time. For example, a dual power device may accept one battery cartridge for single-use batteries and another for rechargeable batteries. In another example, a single battery cartridge type can accept either single-use or rechargeable batteries (but not a mix of types). Dual power devices lack the onboard intelligence to manage different cell chemistries; thus, mixing cell types can result in the problems described above (reduced power, damage, and/or rupture). In some situations, dual power devices can also be inconvenient because the consumer may need to carry both options with them and to know in advance what their power needs will be.

### Pulse Width Modulated (PWM) Loads

As a brief aside, some products have implemented dynamic loading capabilities-dynamic loading potentially offers better performance, longer battery life, and/or improved functionality. So-called Pulse Width Modulation (PWM) is one example of a dynamic loading strategy. Consider an exemplary PWM implementation that powers a Light Emitting Diode (LED) according to a selectable duty cycle. Specifically, the anode of the LED may be connected to the positive end of the battery source and the cathode of the LED may be connected to the drain of an N-Channel metal-oxide-semiconductor field-effect transistor (NMOSFET) switch. The source of the NMOSFET is connected to ground, and the gate is opened and closed by the PWM signal. The perceived brightness of the light is based on the duty cycle, e.g., 100% duty is the maximum brightness, 0% duty is off. Artisans of ordinary skill in the related arts will readily appreciate that other dynamic loading schemes provide similar behavior; these schemes may include, e.g., Pulse Density Modulation (PDM), Pulse Amplitude Modulation (PAM), and other duty cycle-based modulation techniques.

Dynamic loading schemes provide substantial benefits over resistive dimming alternatives. NMOSFETs do not burn power during their off cycle which reduces power consumption and heating; this allows devices to stay cooler and last longer. Also, an NMOSFET is cheaper and smaller compared to power resistors. Unfortunately, these savings come at the cost of voltage stability and may also increase noise in the system.

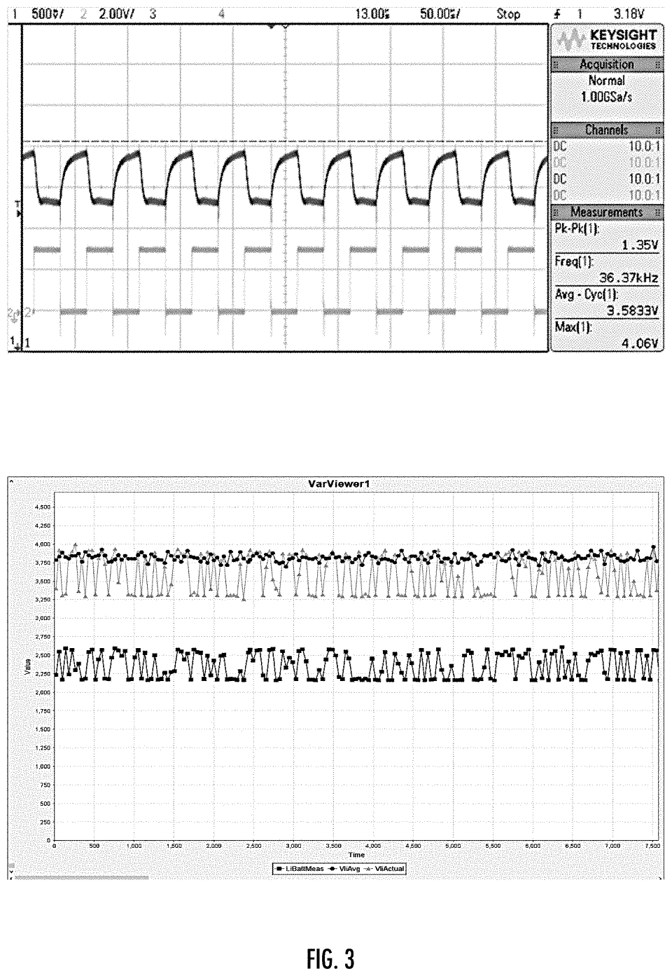

FIG. 3 shows a PWM LED implementation useful to illustrate battery capacity measurements under dynamic loading conditions. As shown, an NMOSFET gate is driven on/off at a 50% duty cycle. The battery and circuitry may also have internal resistances (R) and capacitances (C) which affect the rising and falling edges; for example, a square wave input will generate a rounded wave as the resistor-capacitor (RC) circuit charges and discharges (this effect may also be referred to as “1^{st} order decay”).

Battery capacity can be accurately measured based on Coulomb counting and battery voltage measurements. Unfortunately, these solutions are often cost prohibitive for low-cost applications. More cost-effective alternatives estimate the remaining charge based on the known discharge curve of the battery chemistry (such as was depicted in FIG. 1) and voltage measurements (using an analog digital converter (ADC)). Historically, most low-cost devices are designed for static loading, thus estimation has been an acceptable design choice.

Notably, existing estimation techniques cannot be used under dynamic loading, since voltage is directly affected by the load (e.g., V=iR, i=Cdv/dt, and/or any impedance.) A PWM driven NMOSFET results in highly variable voltage readings that present a challenge in estimating remaining battery capacity. As shown in FIG. 3, directly sampling the 50% duty cycle may capture an off-phase or the RC decay. Typically, measurements at −50% duty cycle have the maximum amount of variation in the battery voltage; however, this may also vary based on current draw, sampling rate, etc. For example, large swings in current draw may cause erratic RC decay readings; similarly, irregular voltage sampling may coincidentally capture more off-phase measurements.

### Example Operation

Aspects of the present disclosure include an intelligent hybrid battery cartridge with the ability to output single-use battery power, rechargeable battery power or both. As used herein, the term “hybrid”, “hybrid power devices”, and their linguistic derivatives, refer to devices that can accept and use multiple types of battery power sources at the same time. Hybrid power devices may include circuitry that monitors power conditions of the different power sources and may make intelligent power management decisions on how to budget available power for a user of the device. Ideally, hybrid power devices can accommodate different battery types, flexibly address different usages, and improve the convenience of use (e.g., the user would not have to carry both battery types to get the benefits of each).

In one exemplary embodiment, a single battery cartridge may store multiple types of batteries and allow the batteries to be used separately, or concurrently. The hybrid battery cartridge may intelligently monitor the availability of the power sources and the power remaining in all power sources; this information may be used to switch between the power sources. Ideally, the exemplary algorithms maximize the power available for the lowest lifetime cost, while also offering the highest flexibility in power options. In one specific implementation, the intelligent hybrid battery cartridge is designed to retrofit existing dry cell powered devices (such as flashlight and lanterns) with hybrid power capability. In some implementations, the intelligent hybrid battery cartridge may also power external devices in a “stand alone” mode (e.g., as a portable battery charger).

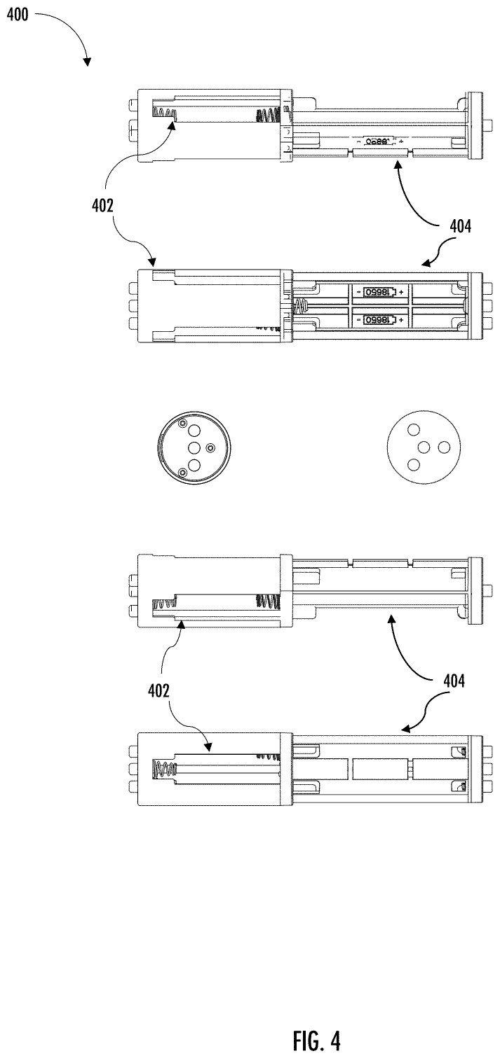

FIG. 4 illustrates six faces of an exemplary hybrid battery cartridge 400 useful to teach aspects of the present disclosure. The hybrid battery cartridge 400 is configured to fit within, and electrically couple to (and communicate with), an electrical device, e.g., a flashlight, lantern, power tool, vaporizer, home electronic apparatus, or another appliance.

A hybrid battery cartridge 400 is configured to output single-use battery power, rechargeable battery power, or both depending on which power options are available (and additional considerations described below). The hybrid battery cartridge 400 may intelligently monitor the availability of the power sources (e.g., determining whether the power sources inserted into the hybrid battery cartridge are operational/present), determine the power remaining in all power sources, switch between the power sources based on factors such as: availability of power, source of power (e.g., which may relate to cost of use), and/or the use of power (e.g., load). In one specific implementation, the algorithm is designed to maximize the power available for the lowest lifetime cost, while also offering the highest flexibility in power options.

Electronics inside the hybrid battery cartridge 400 provide intelligent power management that is powered by the hybrid battery cartridge 400 itself and allows the hybrid battery cartridge 400 to stand alone and provide optional power output for external devices. In some examples, the hybrid battery cartridge 400 is designed to fit into legacy “dumb” devices (devices without, or with less, intelligent power management)-where a battery cartridge was designed to go. During operation, the intelligent power management allows a user to retrofit legacy “dumb” devices (such as flashlight and lanterns) with hybrid power capability.

The hybrid battery cartridge 400 includes battery holders 402 designated for one or more single-use batteries, and battery holders 404 designated for rechargeable batteries. In some implementations, the single-use battery holders 402 and rechargeable battery holders 404 may be able to accept or receive only one battery size; other variants may accept multiple/varied size(s) of battery.

Battery cartridges are generally easier to use than “loose” batteries for large numbers of cells (e.g., three or more). Specifically, a user can easily insert and handle a large number of cells in the cartridge. In one embodiment, the exemplary hybrid battery cartridge 400 may also have openings to allow the user to visually inspect the installed cells of the single-use battery holders 402 and/or rechargeable battery holders 404.

In the illustrated embodiment, there are three single-use battery holders 402, e.g., three AA batteries, and a single rechargeable battery holder 404, e.g., a single 18650 battery. More generally, the number of single-use battery holders 402 and/or rechargeable battery holders 404 may vary based on the intended power output of the hybrid battery cartridge 400, the size/capacity of the single-use batteries, the type of battery (alkaline, zinc carbon, lithium, etc.), and the overall size of the hybrid battery cartridge 400. The most common single-use battery sizes in the United States are AAA, AA (or 14500 for rechargeable cells), C, and D. Other battery form factors include e.g., coin, AAAA, A, B, F, etc.

In some variants, the single-use battery holders 402 and rechargeable battery holder 404 may be on separate ends of the hybrid battery cartridge 400. In other variants, single-use battery holders 402 may be interspersed with rechargeable battery holders 404. Additionally, since single-use cells are more frequently replaced than rechargeable cells, some variants may situate the single-use battery holders 402 around the rechargeable battery holder(s) 404. Such configurations may allow for easier replacement/visual inspection of the single-use cells. In some cases, the rechargeable battery may be pre-installed (and/or not removeable). In still other designs, there may be no designation between types of battery holders 402 and 404; single-use batteries or rechargeable batteries may be inserted into either/any battery holder and the type of battery is determined by the logic of the hybrid battery cartridge 400.

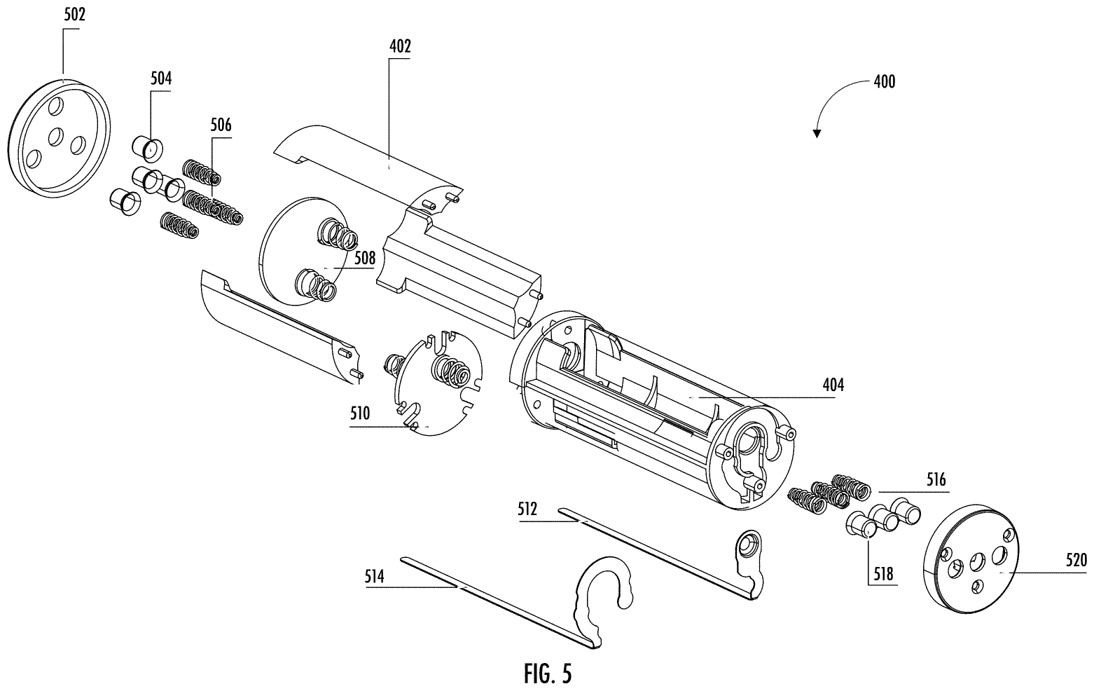

FIG. 5 is an exploded view of the hybrid battery cartridge 400 useful to teach aspects of the present disclosure. The hybrid battery cartridge 400 includes covers 502 and 520, electrical contacts (“rivets”) 504 and 518, spring contacts 506 and 516, a single-use battery holder 402, printed circuit boards (PCB) 508 and 510, a rechargeable battery holder 404, and electrical leads (“metal sheets”) 512 and 514. The hybrid battery cartridge 400 may also include additional features including without limitation: a universal serial bus (USB) charging port (and/or a USB charging wire), LEDs, other user interface elements, etc.

The covers 502 and 520, and battery holders 402 and 404 form a housing that surrounds and provides a rigid structure for the other components of the hybrid battery cartridge 400. In one exemplary embodiment, these non-conducting portions of the hybrid battery cartridge 400 may be made from plastics such as acrylonitrile butadiene styrene (ABS) which may be injection molded for larger production runs. Any other non-conductive material with sufficient rigidity to securely hold batteries may be used with equal success, including thermoplastic polymers, etc.

In the illustrated embodiment, the cover 502 is coupled to the single-use battery holder 402 and the cover 520 is coupled to the rechargeable battery holder 404. The covers 502 and 520 each have a number of apertures for electrical contacts (the rivets 504 and 518) to pass through.

The rivets 504 and 518 are configured to provide electrical power to external components, e.g., a device that can connect to hybrid battery cartridge 400. The rivets 504 and 518 may be made from any conductive material (e.g., steel, copper). The rivets 504 and 518 are configured to transfer power to/from batteries housed within the hybrid battery cartridge 400. In one such variant, the rivets may also be used to provide data/control signaling; for example, the rivets may carry electrical signals to/from a microcontroller (MCU) on, e.g., PCB 510, that observes the charging/discharging cycle of the cells. The usage chip may monitor and report on the remaining capacity of the single-use and/or rechargeable batteries inside the hybrid battery cartridge 400 as well as the draw from one or more loads. The microcontroller may select or switch power to attached loads between various power sources in the hybrid battery cartridge 400 based on various factors. These factors may include environmental factors (obtained via one or more sensors, e.g., a temperature sensor), user input/instructions via one or more buttons or controls, the available power of single-use batteries in the single-use battery holder 402 (as an absolute value, as a percentage of total battery capacity, or as a percentage of single-use battery capacity), the available power of rechargeable batteries in the rechargeable battery holder 404 (as an absolute value, as a percentage of total battery capacity, or as a percentage of single-use battery capacity), the amount of draw of a load connected to the hybrid battery cartridge 400, the type of load (e.g., an electronic device/an analog device), or the output of the load (via the rivets 504 and 518 or a USB connector).

The spring contacts 506 and 516 are configured to couple to batteries physically and electrically in the battery holders 402 and 404. The coil of the spring contacts 506 and 516 are configured to accurately adjust to variations in battery length with spring tension. The spring contacts 506 and 516 provide a reliable connection to the batteries while maintaining a low contact resistance. The spring contacts 506 and 516 may be made from any conductive material (e.g., metal) that is suitable to being formed into a connector/spring connector.

Metal sheets 512 and 514 are configured to transport power and/or communication from the batteries (e.g., the rechargeable battery and/or the single-use batteries) to the PCBs 508 and/or 510 and through rivets 504 and/or 518 externally to an encapsulating device (e.g., a flashlight). Metal sheets 512 and 514 may be made of e.g., copper, or any suitable conductive material.

As previously alluded to, the hybrid battery cartridge 400 may also include an external device charger interface. In one exemplary embodiment, the external charger interface may be a USB (or any of its derivatives e.g., USB-A, USB-B, USB-C, USB-mini, USB-micro), Thunderbolt, Lightning, FireWire, barrel connectors (e.g., 5.5 mm×2.5 mm, 4.0 mm×1.7 mm, 3.5 mm×1.35 mm, 3.0 mm×1.1 mm, 2.5 mm×0.7 mm, etc.), or any other charger connection interface that can transmit power and/or data to another device. In some variants, power conversion circuitry may be used with universal adapters to support an even larger range of devices.

PCBs 508 and 510 are configured to electrically connect to batteries inserted into the battery holders 402 and 404. PCBs 508 and 510 may mechanically support additional electronic components soldered or otherwise electrically connected using conductive pads designed to accept the component's terminals. PCBs 508 and 510 may also electrically connect these components to each other and other parts of the hybrid battery cartridge 400 using traces, vias, planes, and other features etched from one or more sheet layers of copper laminated onto and/or between sheet layers of a non-conductive substrate. PCBs 508 and 510 (and their electrical components) may be powered by one or more batteries in the battery holders 402 and 404 and/or external power (if available, while recharging, etc.)

The additional electronic components soldered onto PCBs 508 and 510 may include microcontrollers, memory, charging circuitry, and/or other circuitry. For example, PCB 508 may include circuitry to prevent over (and under) charging of the rechargeable batteries inserted into the rechargeable battery holder 404. In one example, the circuitry includes a protection circuit module (PCM) configured to manage basic safety functions of the battery pack including over-voltage, under-voltage, and over-current. In some cases, the PCM additionally monitors battery temperature which can be used to infer aspects of battery operation (e.g., performance, charging state, etc.) In some additional examples, PCB 508 includes a secondary safety circuit to protect the batteries from charge in the event the primary safety circuit fails.

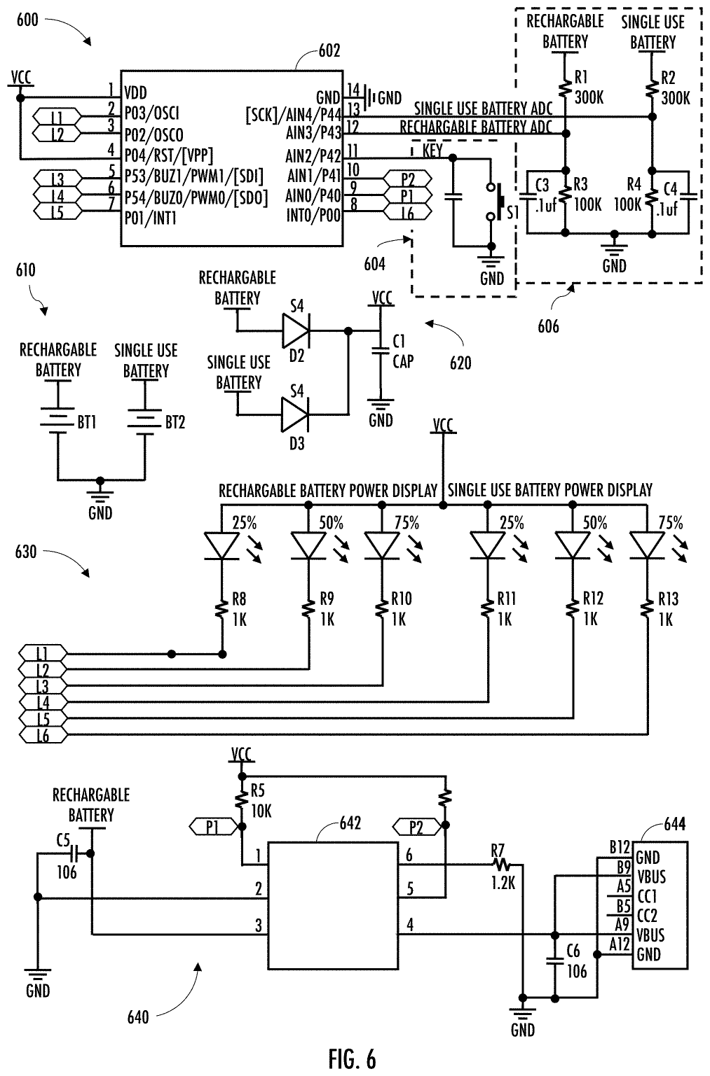

PCBs 508 and 510 of hybrid battery cartridge 400 may also include one or more integrated circuits (IC) that determines power to be used based on the application. For example, the IC may prioritize the use of rechargeable batteries until the remaining charge/power is reduced to 10% battery life and then switches to single-use battery power. In another example, the IC (and code running on the IC) determines the required consistent power output for either/both single-use or rechargeable batteries and provisions power accordingly. In one specific instance, the IC selects a first battery usage configuration when operating as a battery cartridge within a flashlight and selects a second battery usage configuration when charging a cell phone (via e.g., a built in USB cable). Various aspects of IC operation are discussed in greater detail hereinafter (see e.g., FIG. 6 below).

FIG. 6 is a circuit diagram illustrating exemplary circuits 600, 610, 620, 630, and 640 and their constituent components (implemented within PCBs 508 and 510 of a hybrid battery cartridge 400), useful to teach aspects of the present disclosure.

An exemplary circuit 600 includes a microcontroller unit (MCU) 602. MCU 602 is a semiconductor IC that includes a processor unit, memory modules, communication interfaces and peripherals. When powered up, the MCU 602 may begin executing the instructions loaded as program data. While the following discussion is presented in the context of an MCU that integrates and fully utilizes its internal RAM and registers to store run-time variables, other types of logic may be substituted with equal success. Examples include application specific integrated circuits (ASICs), programmable logic devices (PLDs) and/or field programmable gate arrays (FPGAs), as well as microprocessors with externally addressable registers and memory.

In one specific implementation, the MCU 602 controls the operation of hybrid battery cartridge 400 based on internal firmware (instructions) stored within a non-transitory computer-readable medium. The firmware may include multiple static tasks of known complexity. MCU operations may include the intelligent power management algorithms described in greater detail below. Other processor subsystem implementations may multiply, combine, further subdivide, augment, and/or subsume the foregoing functionalities within these or other processing elements. For example, microprocessor embodiments may support software for tasks of arbitrary complexity/best-effort and/or manage various device subsystems (e.g., user interface subsystem, network/data interface subsystem). Such implementations may run basic operating system (OS) functionality (power management, device management, UX), memory management, etc.

In one embodiment, the MCU 602 comprises a commodity microcontroller such as the MC32P7031 (e.g., manufactured by Shanghai Microelectronics, Co. Ltd. (https://www.sinomcu.com/upload/serviceSupport/serviceFile/usermanual/MC32P70 31%E7%94%A8%E6%88%B7%E6%89%8B%E5%86%8C_V1.9.pdf, retrieved Jan. 1, 2022, and incorporated by reference herein in its entirety). The MCU 602 may include a one-time-programmable (OTP) memory that permits data to be written to memory only once and retains values upon a loss of power. In other examples, the memory may be re-programmable. The module may also include one or more analog-to-digital (AD) modules, resistor-capacitor (RC) oscillators, timers, pulse-width modulation (PWM) modules, and low voltage disconnect (LVD) modules.

During operation, the single-use and rechargeable batteries drive their respective voltages (first circuit 610). As previously alluded to, directly connecting different battery chemistries can be undesirable; consequently, the two different types of batteries are connected by diodes to VCC. Large differences in voltages will cause the diodes to block reverse currents (second circuit 620).

While the illustrated embodiment depicts a simple scheme for protecting cells from reverse currents, more sophisticated techniques may use the MCU 602 to control switches that switch-in/switch-out battery cells. In one such implementation, the MCU 602 may switch-in rechargeable cells (single-use cells may or may not be concurrently connected) until the rechargeable cells are below a reserve threshold (e.g., 10%). Once the rechargeable cells fall below the reserve threshold, the rechargeable cells are switched out and the single-use cells are switched-in (or remain connected). In some variants, the rechargeable cells may be switched back in after the single-use cells are fully depleted. In other cases, the reserved power may only be used for specific applications (e.g., charging another device such as a phone).

In one embodiment, the MCU 602 may draw power from one or more of the connected cells. In other embodiments, the MCU 602 may have its own dedicated power to ensure that the power management functionality is always on. Still other embodiments may drive the MCU 602 from a subset of the battery cells (e.g., a rechargeable cell to prevent draining the single-use cells, etc.); in some such variants, the MCU 602 may have access to the reserve power.

In one exemplary embodiment, the MCU 602 drives CMOS-based switches to open/close connections. CMOS switches may include e.g., single pole single throw (SPST), single pole double throw (SPDT), double pole single throw (DPST), double pole double throw (DPDT), and/or any higher-order combinations of poles/throws. As a brief aside, each “pole” refers to the number of circuits that are controlled by the switch. For instance, a single pole connects one circuit, a double pole connects two independent circuits. Each “throw” refers to the number of positions; a single throw closes its circuit(s) in one position (the other position is an open circuit); a double throw closes a first circuit in a first position, and a second circuit in a second position. More generally, any electrical or mechanical component for selectable connection/disconnection (switching) of the battery cells to the rest of the electrical system may be substituted with equal success. Referring back to the MCU 602 of FIG. 6, a circuit sub-segment 604 includes a switch for MCU 602. The physical switch can be used to provide user input to the MCU 602. Another circuit segment 606 includes analog-to-digital converters (ADC or A/D converter) for a rechargeable battery (or an array of rechargeable batteries) and for a single-use battery (or an array of single-use batteries). In one specific implementation, the MCU 602 may use the ADC circuits to determine the remaining power for the single-use and/or rechargeable battery arrays responsive to user input (e.g., via the circuit sub-segment 604). In other words, the MCU 602 may measure the unloaded voltage of the cells to estimate the power remaining in the batteries (according to their battery chemistries). Circuit segment 606 may act as a voltage divider and low-pass filter for the rechargeable battery and single-use battery voltages. The voltage divider/low-pass filter may filter out high-frequency noise to provide a stable estimate of the remaining power in the batteries and/or the state of charge (SOC) in the rechargeable batteries.

The third circuit 630 is configured to display the estimated remaining power; specifically, leads L1-L6 of MCU 602 are pulled down to light LEDs indicating whether there is more than 25%, 50%, or 75% charge remaining in the rechargeable battery/batteries or the single-use battery/batteries. While LEDs are shown, any other suitable user interface may be substituted with equal success, including a speaker for an audio alert, a display, etc.

The fourth circuit 640 includes a charge management chip 642; in this implementation, the charge management chip is coupled to a USB interface 644. In one embodiment, the charge management chip 642 comprises a commodity charger such as the 4057 linear lithium-ion battery charger (e.g., manufactured by Analog Devices, Inc. (https://www.analog.com/media/en/technical-documentation/data-sheets/4057f.pdf, retrieved Jan. 1, 2022, and incorporated by reference herein in its entirety). In one example, the charge management chip 642 may include temperature sensors. This may be useful in testing whether the battery's temperature is too low or too high for charging. If the battery is too hot or cold, the charge management chip 642 may suspend charging operations. Charge management chip may support pre-charge, constant current charge, and constant voltage charge modes for charging rechargeable batteries via the USB port. A wall adapter can be used to connect the hybrid battery cartridge 400 to municipal power (also referred to as mains power, wall power, etc.) or to charge the rechargeable battery.

In one exemplary embodiment, the charge management chip and/or MCU may additionally charge an external device using the battery power via, e.g., a USB port on the hybrid battery cartridge 400. The external device may be charged via either the single-use or rechargeable battery or both. Additionally, single-use and/or rechargeable batteries may power an encapsulating device (e.g., a flashlight). The management of the battery usage to power the encapsulating device and/or an attached device may be with charge management chip and/or MCU.

In one such implementation, the charge management chip may determine the nature of the device that is connected to it. For example, the USB bus protocols (such as “Universal Serial Bus Type-C Cable and Connector Specification,” Release 2.0, published by the USB Implementer's Forum, August 2019, and incorporated by reference herein in its entirety) provides enumeration protocols that allow a connected device to identify its capabilities. Specifically, when a device is “hot-plugged”, the charge management chip and/or connected device may perform a discovery and/or enumeration process. During discovery and/or enumeration, the charge management chip may e.g., determine whether the connected device can provide or draw power. If the connected device can provide power, then the charge management chip will recharge the rechargeable cells; alternatively, if the connected device draws power, the cells may provide power. In some variants, the rechargeable cells may provide reserve power for specific applications (e.g., to provide a charge to a cell phone).

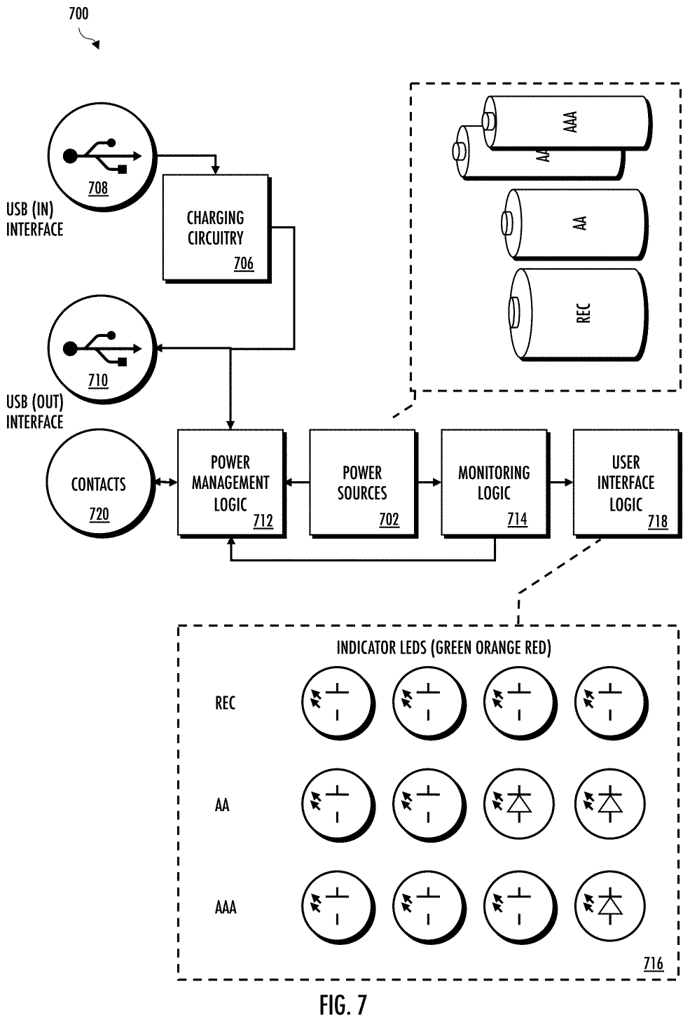

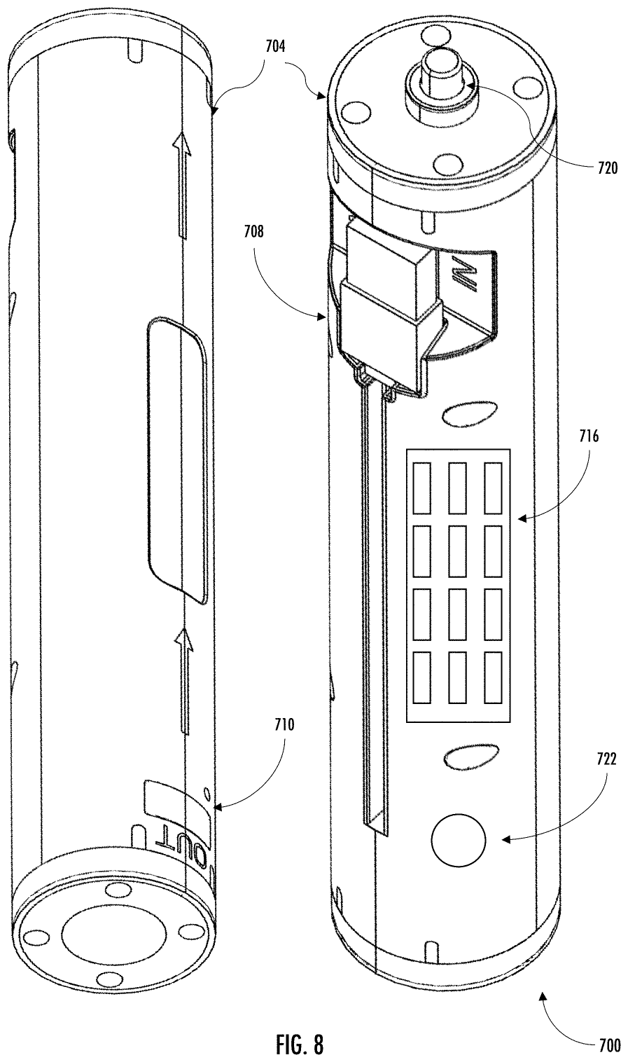

FIG. 7 is a logical block diagram of one exemplary hybrid battery cartridge 700 useful to illustrate various aspects of the present disclosure. FIG. 8 is a graphical representation of two perspective views of the physical form factor corresponding to the hybrid battery cartridge 700.

As shown in FIG. 7, the hybrid battery cartridge 700 includes multiple power sources 702. In the illustrated embodiment, the multiple power sources may include: a 3.7V lithium-ion battery (rechargeable), one AA battery (4.5V low current draw), and two AAA batteries (4.5V high current draw). The power sources 702 may be in multiple (internal) battery holders/compartments inside a housing 704 of the hybrid battery cartridge 700.

The hybrid battery cartridge 700 may include charging circuitry 706 and associated interfaces to recharge its own rechargeable battery and/or other connected devices. For example, some hybrid battery cartridges 700 may include an external interface, such as USB cable 708, to charge the charge the 3.7V lithium-ion/rechargeable battery. In some variants, for example a battery cartridge with a with a large form factor, a solar panel, a hand crank, or another mechanism may be used to charge the rechargeable battery. While the hybrid battery cartridge 700 is described with relatively modest battery supplies, other charging interfaces (and associated power requirements) may be substituted with equal success. For example, heavy duty work site models may offer e.g., 12V and/or 18V battery pack charging (for power tools) while attached to a wall socket or mains power.

In some variants, the hybrid battery cartridge 700 may include external charging and/or data transfer capability via an external interface. For example, some hybrid battery cartridges 700 may include a USB port 710 to charge an attached smart phone or other peripheral device or USB cable 708 to charge the rechargeable battery of the hybrid battery cartridge 700.

Examples of such external charging interfaces may include e.g., mini-USB, micro-USB, USB-C, Lightning®, Power over Ethernet (PoE), Qi wireless charging, and/or other power delivery interfaces. In some such variants, the hybrid battery cartridge 700 may also allow data/media transfer to or from an attached device.

Each of the operational modes (e.g., different load types, different load interfaces (via USB port 710 or contacts 720), charging modes, etc.) may have different power requirements. The power management logic 712 (hardware, firmware, or software) selects one or more power sources from the available power sources 702 that is suitable for the operational mode. In some cases, the power management logic 712 may select the power source based on the operational mode. For example, the hybrid battery cartridge 700 may be installed in a flashlight that may draw power when in use and use the rechargeable battery when available and with sufficient reserve power and single use batteries when there is below a threshold amount of remaining power in reserve in the rechargeable battery. Conversely, when powering an electronic device (via, e.g., USB port 710) to provide relatively stable voltage levels, the rechargeable 3.7V lithium-ion battery may be used, when available, despite the remaining power of the rechargeable battery being below a reserve power threshold. Still other variants may allow the user to select the appropriate power source via user interface logic 718 and button 722. For example, a user may want to manually switch between the rechargeable 3.7V lithium-ion battery, the AA cell, and the AAA cells.

In one exemplary embodiment, characteristic functions may be stored into the monitoring logic 714 for battery capacity estimation. Specifically, the characteristic functions are measured and calculated for the hybrid battery cartridge 700, at 100%, 75%, 50% and 25% duty cycles using a specified sample rate (e.g., ˜40 Hz). The characteristic functions correspond to each of the different battery configurations used by the hybrid battery cartridge-for example, each of the 3.7V lithium-ion batteries (rechargeable), the AA battery (dry cell), and two AAA batteries (dry cell) would have different characteristic functions. During operation, the monitoring logic 714 determines its battery configuration and collects time averaged battery voltage measurements. The monitoring logic 714 may use the measured voltage to look-up the estimated remaining battery capacity based on the specific characteristic function for the duty cycle, sample rate, battery configuration, operational mode, and/or any other relevant parameter. The estimated remaining battery capacity may also be used to calculate a rate of change in the remaining battery capacity-this rate of change corresponds to the estimated current draw. The estimated remaining battery capacity and rate of change are collectively referred to throughout as the “usage estimates.” The usage estimates can be provided to the user via the user interface logic 718. In some variants, the monitoring logic 714 may also inform the power management logic 712. For example, the current load, the remaining capacity, and/or current draw may be used by the power management logic 712 to select an appropriate power source.

In one specific implementation, the user interface logic 718 controls a usage gauge 716 that visually represents usage estimates with a numerosity and color code; in this example, the first row of 4 light emitting diodes (LEDs) correspond to the 3.7V lithium-ion battery, the second row corresponds to the AA battery, and the third row corresponds to the two AAA batteries. The LEDs are enabled according to the estimated remaining battery capacity at the current duty cycle. For instance, 2 LEDs in the first row indicates that the 3.7V lithium-ion battery has about 50% of its capacity, 3 LEDs in the second row indicates that the AA battery has about 75% of its capacity, and 1 LED in the third row indicates that the two AAA batteries have about 25% of its capacity, etc. Additionally, each LED emits light in one of three colors that dynamically correspond to the current draw: red (high current draw), orange (moderate current draw), and green (low/no current draw). So, as an example, if the first row is lit red, then the 3.7V lithium-ion battery has high current draw (and is rapidly depleting). If the second row is lit orange, then the AA battery is under moderate use, etc. In other implementations, two rows of LEDs are in that correspond to rechargeable and single-use batteries. Multiple battery types within those groupings maybe combined and, for example, the total battery capacity of the group used to calculate and display the remaining capacity.

In one specific variant, the time averaged battery voltage measurements are calculated over a rolling window of values (e.g., 4, 8, 16, 32-value average, etc.). Notably, the battery voltage measurements are positive values so computationally simple addition and/or accumulation logic may be used. Applications that may have negative values may need more complex multiplication and/or polarity correction (e.g., RMS and/or energy estimation type logic). Typically, the instantaneous measured voltage may drop below the threshold for several readings in a row before the average voltage falls below the threshold. As a result, very large rolling windows may result in a “lag” or measurement hysteresis; conversely, very small rolling windows may be more strongly influenced by only a few sample points (noisy). Empirically, a 16-value average provides a good balance of stability and responsiveness for many lantern applications.

Some battery chemistries exhibit misleading behavior based on load and/or environmental factors. For example, certain types of batteries may have a “false” recovery that results in a higher resting voltage; however, the voltage rapidly drops to a more representative voltage under load. In other cases, batteries may have a different characteristic voltage based on ambient temperature, humidity, atmospheric pressure, etc. In some variants, the device logic (hardware, firmware, or software) may use a “ratcheting” level that prevents misleading behavior. In other words, the display cannot rise above a breached lower threshold until e.g., a battery has been changed/recharged or otherwise reset. For example, once the remaining capacity has fallen from 75% to 50%, the device logic will cap the subsequent readings to 50%. The device logic will only re-enable the 100% and 75% levels after a power cycle, batteries change (or charged), etc.

In some embodiments, the user interface logic 718 provides a continuous read-out. In other embodiments, LEDs may be turned off when providing power via contacts 720 as the hybrid battery cartridge 700 is inserted inside another device (where a user may be unable to see the LEDs on the usage gauge 716). Other embodiments may allow the user to selectively check the battery usage estimates only “as-needed.” For example, all LED rows may be only momentarily lit when the user presses the button 722, or a user may be able to individually check the power for only one of the power sources (e.g., the button 722 may allow a user to toggle through power sources to check the status of just one of the 3.7V lithium-ion battery, AA battery, or two AAA batteries). Still other implementations may allow display status briefly at the start of and/or periodically during, a specific operating mode. For example, plugging a USB charging device may draw current from the 3.7V lithium-ion battery to start, and flash status every minute (via the first row of LEDs). Once the rechargeable battery is depleted, the external device may be switched to the AA batteries-status may flash every minute via the second row of LEDs, etc.

More generally, the user interface logic 718 allows a user to determine the ongoing usage and remaining capacity for any one of the battery sources. In some cases, the user may be alerted as to when to change batteries, switch power sources, and/or reduce usage. As but one example, a user that is on a camping trip or a remote work site may not have ready access to disposable/single-use batteries. They may stop charging their smart phone to ensure that the hybrid battery cartridge has enough remaining power to provide power to other equipment (e.g., a flashlight). Conversely, they may fully charge their cell phone to ensure they can call out for assistance. In other words, users can use their power usage information to budget their usage according to their needs.

While the foregoing discussion is presented in the context of a specific arrangement and/or color code of LEDs, other arrangements/color codes may be substituted with equal success. Notably, any number of LEDs may be used to signify capacity according to any specific granularity. As one example, 10 LEDs may be used to provide 10% increments (a linear scale). In another example, 4 LEDs may be used to provide logarithmic scale increments (e.g., 10%, 25%, 50%, 100%). Different colors may also be used e.g., red, orange, yellow, green, blue, indigo, violet, etc. to represent different current draws. Still other variants may switch the representation e.g., the color may indicate the percentage left, the number of lit LEDs may represent the current draw. While the foregoing is described in the context of an on-battery-cartridge visual display, other user interface schemes may be substituted with equal success. In some cases, the notifications may be audible and/or haptic. For example, beeps at different note pitches may be used to convey usage estimates. As but one such example, the number of beeps may indicate remaining capacity e.g., four beeps may indicate 100%, three beeps may indicate 75%, etc. The pitch of the beeps may indicate current draw e.g., 440 Hz (A₄ note) may indicate low/no draw, 523.25 Hz (C₅ note) may indicate moderate draw, etc. As another example, a “rumble box” may use similar numerosity/frequency schemes to convey information in a tactile modality. In yet other schemes, usage estimates may be wirelessly transmitted to a remote device (smart phone or laptop) that can remotely notify the user according to an application user interface. A wide variety of other user experience (UX) may be substituted with equal success.

Still further, more sophisticated user interfaces may enable more sophisticated battery configurations. As but one such example, a hybrid battery cartridge could incorporate low power wireless connectivity (e.g., Bluetooth) to connect with a nearby smart phone running an application for configuring the hybrid battery cartridge operation. The smart phone application may display the type, current battery capacity, current usage/power drain, and conditions for switching between battery types, etc. In one specific implementation, the smart phone application may allow a user to set a desired usage and capacity for switching between dry cell and rechargeable cells. As another example, the smart phone application may notify the user when a dry cell should be changed and/or rechargeable cell should be recharged. Still other applications could allow a user to constrain a particular usage or desired performance to certain ones/all batteries. For example, a user could set a duration of use for a flashlight; the batteries may adjust current draw to ensure that the duration of use is met. As another example, a user may enable a high draw “turbo” mode for e.g., dry cells, and rely on rechargeable batteries for a low draw “eco” mode.

In some implementations, the smart phone application may selectively enable/disable features. For example, the smart phone application could read a serial number (or other unique identifier) of the hybrid battery cartridge, flashlight, lantern, or other consumer device. The serial number could be used for product registration and/or software enabled functionality. For example, a flashlight could be sold to a consumer with normal modes; the smart phone-based user interface may be used to unlock e.g., turbo/eco modes, etc. More directly, a product may be sold at a first price, and customers may enable/disable features as needed at a subsequent upsell price. Additionally, product registration may be used to automatically monitor and report theft (which may be a significant consideration for higher market devices).

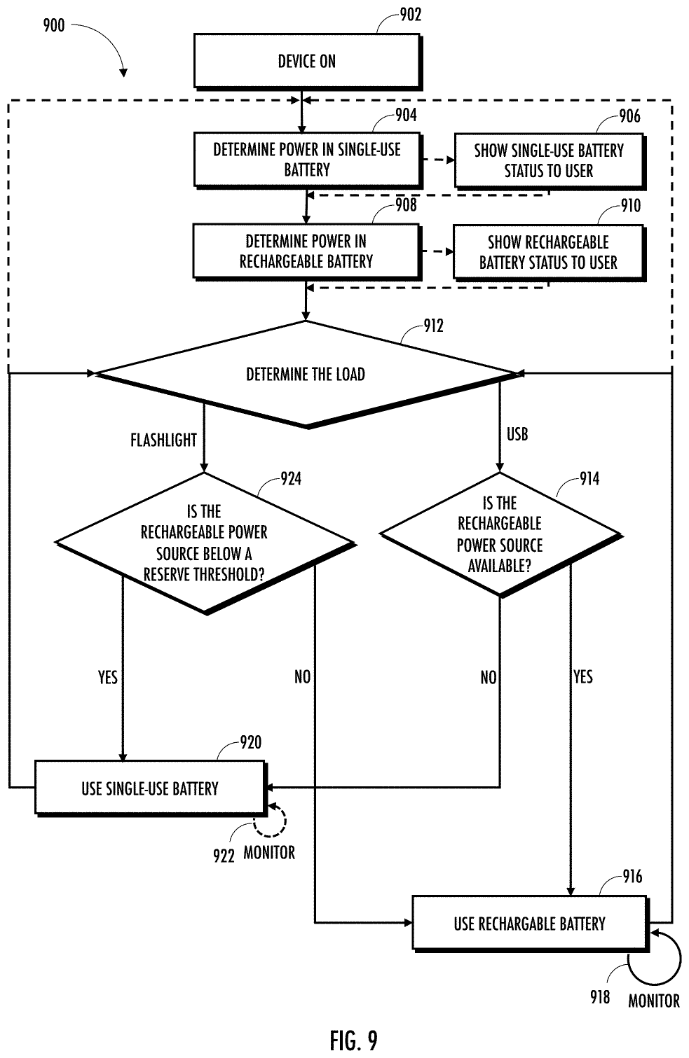

FIG. 9 is a logical flow diagram illustrating an example method 900 according to the present techniques. The techniques of FIG. 9 may be implemented by one or more of the MCU 602, charge management chip 642, or another IC on one or more PCBs 508 and 510 of the hybrid battery cartridge 400 or the power management logic 712 or monitoring logic 714 of the hybrid battery cartridge 700.

Consider the following usage scenarios: a user may intermittently use a device (e.g., a flashlight) and then recharge between uses, the user may use the device for longer durations between recharges (e.g., while camping, etc.), and/or the user may need a charger bank for another device (e.g., a phone). Intermittent charging can quickly run down single-usage cells and is best handled by rechargeable cells. Longer usage without access to charging facilities is best handled with single-use cells. Additionally, recharging other devices is most efficient with similar battery chemistries (e.g., with rechargeable cells); using rechargeable cells for charger functionality is preferable to single-use cells. Notably, existing “dumb” solutions are ill-suited for the foregoing applications.

In one exemplary embodiment, the exemplary hybrid battery cartridge intelligently manages its cells to provide different capabilities. Specifically, the hybrid battery cartridge may rely on rechargeable cells for intermittent use. In this manner, a user may use a device (e.g., a flashlight) for short durations without running down their single-use cells. Additionally, the hybrid battery cartridge may switch to single-use cells to reserve a small amount of power in the rechargeable cells (e.g., 10%, 15%, etc.). In this manner, a user may use replaceable cells in remote locations (e.g., long term camping, etc.) without access to a charger. Finally, in some rare circumstances, the user may need a charger for e.g., a phone; under these cases, the user may charge their phone using the rechargeable cells rather than inefficiently running down their single-use cells. In some cases, this may include allowing access to reserved power. As a related issue, certain rechargeable batteries, e.g., lithium-ion batteries, should not be frequently fully discharged “over-discharged” and recharged (“deep-cycled”) as that can cause the batteries to lose charge capacity over time-the reserve threshold may be set to prevent deep-cycling.

Referring to FIG. 9, the method 900 may be triggered by an encapsulating device (e.g., a flashlight) or by an attached device (e.g., a phone) when the device is powered on (step 902). In other embodiments, the hybrid battery cartridge may execute the method 900 according to its own considerations. For example, the MCU 602 may periodically wake from a sleep state, or power on after a hard reboot (e.g., a battery change/charge). In other variants, the MCU 602 may be triggered by user input (e.g., a push button, etc.) Alternatively, the method 900 may be performed continuously/periodically when the hybrid battery cartridge is powered on.

The MCU 602 may determine a power or charge level in one or more single-use batteries at step 904. As previously noted, see the discussion of FIG. 1 above, the most accurate estimate of the remaining charge in certain types of single-use battery may be determined when there is no (or minimal) current load. Consequently, some variants may measure the voltage of the single-use batteries ahead of time, or right before loading; subsequent estimates may be based on monitored current draw, etc.

The status of the single-use batteries may be shown to the user, at step 906. In one embodiment, the status may include the determined power level of the single-use batteries. This may be displayed using, e.g., LED lights on hybrid battery cartridge 400 or 700 or on the encapsulating device. In some cases, different LEDs may be used to display the power status of the battery. As described above, for example, LEDs may indicate the remaining life of the battery (e.g., in time, amount of/mAh of power remaining, or a percentage of the total battery capacity when new, etc.). In one such example, LEDs indicate whether ˜25%, ˜50%, ˜75%, ˜100% of the battery capacity when new/non-discharged remains. In related examples, LEDs may be used to display the power drain status of the battery based on the current load. In some cases, the LED(s) may display a color, e.g., red, orange, or green, depending on the power status of the battery and/or the power status of the load. Additionally, other mechanisms such as haptic feedback (via e.g., vibrations) or audible tones may be used to indicate the status. In some variants, the status may also include other relevant information e.g., the current load (e.g., high, medium, low, none), time since last change, duration of use, etc.

The MCU 602 may determine a power or charge level in one or more rechargeable batteries at step 908. Notably, remaining charge in the rechargeable batteries often cannot be directly measured by voltage; the rechargeable battery status is typically estimated during charging (based on battery temperature) and tracked throughout usage. The status of the rechargeable batteries may be shown to the user, at step 910. The status may include the determined power level of the batteries. Similar to the foregoing single-use cell status, rechargeable cell status may use different LEDs, different colors, and/or other user feedback mechanisms (haptic, audible tones, etc.) to provide status information.

In some examples, the status of both the single-use batteries and the rechargeable batteries are shown to the user at the same time. In other cases, the status of the single-use batteries and the rechargeable batteries may be separately shown. In some cases, the status of each individual battery may be separately shown. Still other variants may combine the statuses (e.g., without distinction between single-use and rechargeable).

The MCU 602 may determine the load(s) that is currently drawn (or will be imminently drawn) from hybrid battery cartridge 400, at step 912. The load may include the encapsulating device (e.g., a flashlight, LED lamp, power tool) or a load connected to an external port (USB port, a cord connected to a USB port, etc.) on the hybrid battery cartridge 400 (e.g., a phone, camera, speaker).

If the load is at the (USB) port, MCU 602 determines whether the rechargeable power source is available, at step 914. The rechargeable power source is available when the rechargeable power source has enough remaining power to charge at least part of the necessary load. The rechargeable power source is not available if: the battery has no remaining power/charge; if there is no battery installed in the battery holder 404; if the battery is determined to be of the incorrect type; if the battery is defective or non-responsive; or if the power source is operating at an unsuitable temperature (above a first operating temperature threshold (e.g., above 40° Celsius, above 60° Celsius, etc.) or below a second operating temperature threshold (e.g., below 0° Celsius)).

If the rechargeable power source is available (step 914, “yes” branch), then MCU 602 will provide power to the load from the rechargeable battery, at step 916. In one specific implementation, the MCU 602 will direct power from the rechargeable battery to the USB port. MCU 602 monitors the status of the rechargeable battery and the load, at step 918. Monitoring may include periodically determining the status or charge state of the rechargeable battery and determining if a different load needs power (returning to steps 904 or 912). For example, if the load has changed (e.g., from an encapsulating flashlight to a cellphone via the USB charger), the selected power source may be reevaluated.

If the rechargeable power source is not available (step 914, “no” branch), then MCU 602 determines that the load should be fulfilled with the single-use battery, at step 920. MCU 602 directs power from the single-use battery to the USB port. In some examples, MCU 602 monitors the status of the single-use battery, the status of the rechargeable battery, and/or the load, at step 922. Monitoring may include periodically determining the status or charge state of the single-use battery (at step 904), the rechargeable battery (at step 906), and/or determining if a different load needs power (at step 912).

If the load is the encapsulating device (e.g., flashlight), MCU 602 determines whether the rechargeable power source is below a reserve threshold, at step 924. The reserve threshold may define an amount of reserve power to keep available in the rechargeable battery.

In some examples, the reserve power threshold may be a percentage of the total capacity of the rechargeable battery or set of rechargeable batteries (e.g., 10%, 15%). In another example, the reserve threshold is set to a particular amount of charge/energy/current left in the rechargeable battery (e.g., 250 mAh). In a further example, the reserve threshold is set to a particular voltage level of the rechargeable battery (e.g., when the rechargeable battery voltage drops below 3V). In a further example, the reserve threshold is set to a particular battery temperature or change in temperature (e.g., an increase of 5° C. over the last 10 minutes of use). In another example, the threshold is also based on how much charge remains in the single-use batteries (absolute charge, percentage of the total remaining). In another example, the reserve power threshold may be based on a combination of factors.

If the rechargeable power source is above the reserve threshold (step 924, “no” branch), MCU 602 determines that the load should be fulfilled with the rechargeable battery at step 916. MCU 602 directs power from the rechargeable battery to the USB port. MCU 602 monitors the status of the rechargeable battery and the load, at step 918. Monitoring may include periodically determining the status or charge state of the rechargeable battery (at step 906) and determining if a different load needs power (at step 912) and may include determining the status or charge state of the single use battery (at step 904).

If the rechargeable power source is below (or falls below) the reserve threshold (step 924, “yes” branch), then MCU 602 determines that the load should be fulfilled with the single-use battery, at step 920. MCU 602 directs power from the single-use battery to the USB port. In some examples, MCU 602 monitors the status of the single-use battery, the status of the rechargeable battery, and/or the load, at step 918. Monitoring may include periodically determining the status or charge state of the single-use battery (at step 904), the rechargeable battery (at step 906), and/or determining if a different load needs power (at step 912).

### Exemplary Methods

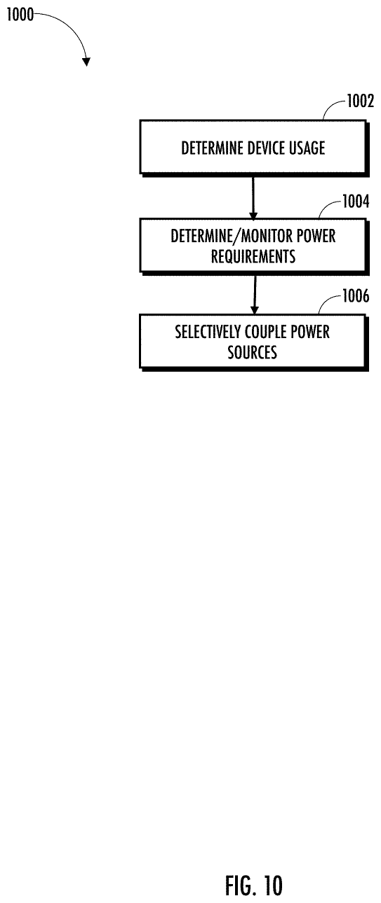

FIG. 10 is a logical flow diagram of a method 1000 for determining a battery usage configuration based on the operating mode in accordance with various aspects of the present disclosure. The techniques of FIG. 10 may be implemented by one or more of MCU 602 and/or charge management chip 642 or another IC on one or more PCBs 508 and 510 of a hybrid battery cartridge 400 or the power management logic 712 or monitoring logic 714 of the hybrid battery cartridge 700.

The hybrid battery cartridge may determine the device usage, at step 1002. The usage determination may identify that the hybrid battery cartridge is being used as a battery cartridge inserted into or onto an encapsulating device (e.g., a flashlight, radio, or power tool). Alternatively, hybrid battery cartridge may determine that the hybrid battery cartridge is being used as an external power bank. In some such variants, the determination may be based on a load (e.g., a cell phone) attached to an onboard USB port. The determination may be based on flagging the activity based on a digital gate (e.g., a pull-up or pull-down resistor based on a load being applied to the USB port or to the contacts on the rivets 504 and/or 518).

While the foregoing examples are presented in the context of a determination made by the device; other implementations may allow the user to set the device usage. For example, the user may use a buttons, switches, or other user interface component to set the device usage. The user interface may be incorporated with the device itself, or externally controlled by another device (e.g., a user application running on a nearby smart phone).

While the foregoing examples are described in the context of a “determination”, other schemes for obtaining the device usage may be substituted with equal success. For example, smart hybrid battery cartridges may actively communicate with the device. Still other examples may “assign” or otherwise “set” a device usage based on the available power capabilities and/or user configuration. For example, a hybrid battery cartridge may determine that its available dry cells and/or rechargeable cells are only able to support emergency phone charging; other device usages (e.g., normal battery operation) may be disabled.

More generally, any operational parameter that may affect battery capability and/or battery usage may be considered for subsequent power requirements of the load. Other examples of such operational parameters may include the type, number, remaining capacity, and/or peak capacity of the battery sources. In addition, alternative power availability and/or load requirements may also be considered. Based on the foregoing information, the hybrid battery cartridge may selectively enable/disable various ones of its battery cells.

The hybrid battery cartridge may determine/monitor the power requirements of the load, at step 1004. In one such implementation, the hybrid battery cartridge may periodically poll the loads to determine the load's current usage requirements. Other implementations may determine the load usage at certain salient points, e.g., the start or end of current draw, in response to a peak draw, in response to current draw exceeding or falling below a threshold, etc. More generally, any usage or environmental consideration that may affect battery health could be substituted with equal success; these may include temperature, humidity, battery life, battery discharge history, etc.

Any number of different factors may be monitored to trigger selective coupling. Examples of such factors may include e.g., power requirements of the load (e.g., an amount of draw, an expected voltage/consistency of voltage), the amount of power remaining in one or more power sources, the power usage across difference cells (e.g., and/or large disparities in power usage), the health status and/or a number of discharge cycles of the rechargeable battery cell(s), and/or the compatibility of power sources to themselves or the load. As but one such example, the amount of power remaining in a rechargeable battery may be used to trigger selection/re-selection to preserve a reserve threshold of power in the rechargeable battery. As another example, power usage may trigger selection/re-selection to balance power sources to, e.g., keep the remaining power even.

In response to a triggering event, the hybrid battery cartridge may selectively couple power sources, at step 1006. For example, the power requirements of a load may exceed the power discharge availability of a particular power source (e.g., a high-power mode on a flashlight). Power sources may include single-use batteries and rechargeable batteries or groups of different single use or rechargeable batteries. For example, hybrid battery cartridge may determine to use a maximum discharge power from the rechargeable battery and 20% of the maximum discharge power from the single-use battery for use in increasing the brightness of the flashlight. Likewise, the hybrid battery cartridge may determine to use 80% of maximum discharge power of the rechargeable battery and use none of the power from the single-use battery to charge a cellphone using the USB port.

### Additional Configuration Considerations

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein any reference to any of “one embodiment” or “an embodiment”, “one variant” or “a variant”, and “one implementation” or “an implementation” means that a particular element, feature, structure, or characteristic described in connection with the embodiment, variant or implementation is included in at least one embodiment, variant or implementation. The appearances of such phrases in various places in the specification are not necessarily all referring to the same embodiment, variant or implementation.

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A battery cartridge apparatus, comprising:
a first battery holder configured to hold a single-use battery;
a second battery holder configured to hold a rechargeable battery;
a microcontroller unit; and
a non-transitory computer-readable medium comprising instructions which, when executed by the microcontroller unit, causes the battery cartridge apparatus to:
determine a load attached to the battery cartridge apparatus;
determine whether the rechargeable battery has an available power below a reserve threshold based on the load; and
power the load using a power source selected from one of the single-use battery and the rechargeable battery based on whether the rechargeable battery has the available power below the reserve threshold.

2. The battery cartridge apparatus of claim 1, further comprising:
a universal serial bus output interface; and
when the load is determined to be via the universal serial bus output interface, the instructions further cause the battery cartridge apparatus to select the power source based on whether power from the rechargeable battery is available.

3. The battery cartridge apparatus of claim 1, where the reserve threshold comprises a value equal to or less than 15% of a rechargeable battery capacity.

4. The battery cartridge apparatus of claim 1, where the instructions further cause the battery cartridge apparatus to monitor a second available power of the power source.

5. The battery cartridge apparatus of claim 4, where the power source comprises the rechargeable battery at a first time; and
Where the instructions further cause the battery cartridge apparatus to re-select the single-use battery to be the power source at a second time, based on the second available power.

6. The battery cartridge apparatus of claim 1, where the instructions further cause the battery cartridge apparatus to:
monitor a first status of the load to determine whether the load has changed; and
reevaluate the power source based on the first status.

7. The battery cartridge apparatus of claim 1, further comprising light emitting diodes; and
where the instructions further cause the battery cartridge apparatus to display a status of the first battery holder via the light emitting diodes.

8. The battery cartridge apparatus of claim 7, where the status indicates an amount of power remaining for the single-use battery.

9. The battery cartridge apparatus of claim 7, where the status indicates an amount of power draw for the single-use battery.

10. The battery cartridge apparatus of claim 1, further comprising one or more light emitting diodes; and
where the instructions further cause the battery cartridge apparatus to display a status of the second battery holder. ii. The battery cartridge apparatus of claim 7, where the status indicates an amount of power remaining of the rechargeable battery.

12. The battery cartridge apparatus of claim 7, where the status indicates an amount of power draw currently on the rechargeable battery.

13. A method of selecting a power source in a hybrid battery, comprising:
determining a usage of a device electrically coupled to the hybrid battery comprising a first power source and a second power source;
determining power requirements of the device; and
selectively coupling at least one of the first power source and the second power source based on the power requirements.

14. The method of claim 13, where selectively coupling the at least one of the first power source and the second power source is further based on a reserve threshold of the first power source.

15. The method of claim 13, where selectively coupling the at least one of the first power source and the second power source is based on the power requirements of the device exceeding a power discharge availability of the first power source.

16. A lighting apparatus comprising:
a light emitting device;
a housing coupled to the light emitting device and configured to accept a hybrid battery cartridge; and
where the hybrid battery cartridge, comprises:
a first battery holder configured to hold a single-use battery;
a second battery holder configured to hold a rechargeable battery;
a microcontroller unit; and
a non-transitory computer-readable medium comprising instructions which, when executed by the microcontroller unit, causes the hybrid battery cartridge to:
determine a load attached to the hybrid battery cartridge;
determine whether the rechargeable battery has an available power below a reserve threshold based on the load; and
power the load using a power source selected from one of the single-use battery and the rechargeable battery based on whether the rechargeable battery has the available power below the reserve threshold.

17. The lighting apparatus of claim i6, where the instructions further cause the hybrid battery cartridge to determine the reserve threshold based on a health status of the rechargeable battery.

18. The lighting apparatus of claim i6, where the hybrid battery cartridge further comprises a first electrical output and a second electrical output; and
where the instructions further cause the hybrid battery cartridge to determine which electrical output of the first electrical output and the second electrical output the load is drawing from.

19. The lighting apparatus of claim 16, where the instructions further cause the hybrid battery cartridge to determine a power draw of the load.

20. The lighting apparatus of claim 19, where the power source is selected based on the power draw of the load.
